(19) United States
(12) Patent Application Publication
(10) Pub. No.: US 2025/0293294 A1
(43) Pub. Date: Sep. 18, 2025

(54) SULFIDE-BASED SOLID ELECTROLYTE WITH IMPROVED DUCTILITY AND FRACTURE STRENGTH

(71) Applicants: Hyundai Motor Company, Seoul (KR); Kia Corporation, Seoul (KR)

(72) Inventors: Jae Young Kim, Seoul (KR); Sang Heon Lee, Seoul (KR); Sang Soo Lee, Seoul (KR); So Young Kim, Seoul (KR); Sun Ho Choi, Seoul (KR); Ho Cheol Shin, Seoul (KR); Kwang Jin Kim, Seoul (KR); Byeong Sun Jun, Seoul (KR); Wo Dum Jung, Seoul (KR); Geun Hyeong Shin, Seoul (KR); Hong Seok Min, Seoul (KR); Dae Yeon Hwang, Seoul (KR)

(21) Appl. No.: 18/911,444

(22) Filed: Oct. 10, 2024

(30) Foreign Application Priority Data
Mar. 15, 2024 (KR) 10-2024-0036128

(51) Int. Cl. H01M 10/0562; H01M 10/0525

(52) U.S. Cl. CPC H01M 10/0562; H01M 10/0525; H01M 2220/20; H01M 2300/008

(57) ABSTRACT

A sulfide-based solid electrolyte with an argyrodite crystal structure is represented by the formula Li₆₋ₐPS₅₋ₐX₁₊ₐ, where X is one or more halogen elements selected from Cl, Br, I, and their combinations, and ‘a’ ranges from 0 to 0.5. The halogen elements are doped at 4a, 4c sites, or both within the argyrodite structure. Variations of this composition include Li_{5.5}PS_{4.5}X_{1.5}, where X can be single or mixed halogens, such as Cl, Br, I, or combinations thereof. The solid electrolyte may be synthesized using a ball milling process to ensure uniform halogen distribution and achieve a disordered crystal structure that enhances ductility and fracture strength. Mechanical properties such as formation energy, bulk modulus, shear modulus, Young's modulus, and Poisson's ratio are optimized for improved performance. Additionally, this electrolyte can be used in lithium-ion batteries, which are suitable for vehicle applications.

### CROSS-REFERENCE TO RELATED APPLICATION

This application claims, under 35 U.S.C. § 119 (a), the benefit of Korean Patent Application No. 10-2024-0036128, filed on Mar. 15, 2024, the entire contents of which are incorporated herein by reference.

### BACKGROUND

### Technical Field

The present disclosure relates to the field of solid electrolytes for use in electrochemical devices. More specifically, it pertains to sulfide-based solid electrolytes with an argyrodite crystal structure, designed to enhance mechanical properties such as ductility and fracture strength. These solid electrolytes are particularly suitable for application in lithium-ion batteries, which can be used in various electronic devices and electric vehicles. The disclosure also covers methods for synthesizing these electrolytes and their integration into battery systems.

### Background Art

Lithium-ion batteries are widely used in various devices that require energy storage. Depending on the field of application thereof, various battery characteristics are required, such as high energy density, long cycle life, fast charging and discharging, high/low-temperature battery operating performance, and the like.

Recently, in order to solve environmental problems caused by carbon dioxide (CO₂), the use of fossil fuels has been avoided, so the industry of automobiles, which are a means of transportation, is showing great interest in electric vehicles that use secondary batteries. Currently developed lithium-ion batteries may travel approximately 400 km on a single charge, but problems such as instability at high temperatures and fire still occur. With the goal of solving these problems, many companies are competitively developing next-generation secondary batteries.

All-solid-state batteries, which are receiving attention as next-generation secondary batteries, have all components made of solids, and thus they have the advantage of low risk of fire and explosion and high mechanical strength compared to lithium-ion batteries that use flammable organic solvents as electrolytes.

As solid electrolytes for these all-solid-state batteries, oxide-based solid electrolytes and sulfide-based solid electrolytes may be used, and in particular, thorough research into sulfide-based solid electrolytes with high lithium ion conductivity is ongoing. However, most solid electrolyte composition patents aim to improve ionic conductivity and electrochemical stability and do not specify mechanical properties of solid electrolytes.

### SUMMARY OF THE DISCLOSURE

The present disclosure relates to a sulfide-based solid electrolyte with improved ductility and fracture strength, and more particularly to a sulfide-based solid electrolyte. in which ductility and fracture strength may be improved by doping a sulfide-based solid electrolyte having an argyrodite crystal structure with at least two types, preferably three types of halogen elements.

The present disclosure has been made keeping in mind the problems encountered in the related art, and an object of the present disclosure is to provide a sulfide-based solid electrolyte that exhibits advantageous mechanical properties as a solid electrolyte used in all-solid-state batteries.

In particular, an object of the present disclosure is to provide a sulfide-based solid electrolyte with high ductility and fracture strength by extending the types of halogen elements, with which a sulfide-based solid electrolyte having an argyrodite crystal structure is doped, to a ternary composition.

The objects of the present disclosure are not limited to the foregoing. The objects of the present disclosure will be able to be clearly understood through the following description and to be realized by the means described in the claims and combinations thereof.

In some embodiments, a sulfide-based solid electrolyte comprises an argyrodite crystal structure and is represented by the formula Li₆₋ₐPS₅₋ₐX₁₊ₐ, wherein X is one or more halogen elements selected from Cl, Br, I, and combinations thereof, and a is from 0 to 0.5. The argyrodite crystal structure is doped with the one or more halogen elements at 4a sites, 4c sites, or both. In some embodiments, the sulfide-based solid electrolyte is represented by the formula Li_{5.5}PS_{4.5}X_{1.5}, where X is one or more halogen elements selected from Cl, Br, I, and combinations thereof. In some embodiments, X comprises at least two halogen elements selected from Cl, Br, and I. The electrolyte can be represented by the formula Li_{5.5}PS_{4.5} (Br, Cl)_{1.5}, Li_{5.5}PS_{4.5}(Cl, I)_{1.5}, or Li_{5.5}PS_{4.5}(Br, I)_{1.5}.

In some embodiments, X comprises all three halogen elements Cl, Br, and I, and is represented by the formula Li_{5.5}PS_{4.5}(Br, Cl, I)_{1.5} or Li_{5.5}PS_{4.5}Br_{b}Cl_{c}I_{d}, wherein b is from 0.25 to 1.00, c is from 0.25 to 1.00, and d is from 0.25 to 0.50, with b+c+d equaling 1.5. Specifically, the electrolyte can be represented by Li_{5.5}PS_{4.5}Br_{1.00}Cl_{0.25}I_{0.25}. The formation energy of this electrolyte ranges from about −1.116 to about −1.224 eV/atom, with a bulk modulus from about 24.39 to about 26.69 GPa, shear modulus from about 12.66 to about 13.68 GPa, Young's modulus from about 32.37 to about 34.81 GPa, and Poisson's ratio from about 0.27 to about 0.29.

In some embodiments, the electrolyte further comprises an anion selected from F- and combinations of F- with Cl, Br, or I. The electrolyte may be synthesized using a ball milling process to ensure uniform distribution of the halogen elements within the argyrodite crystal structure. The halogen elements are doped at both 4a and 4c sites to create a more disordered crystal structure, thereby improving ductility and fracture strength.

In some embodiments, a lithium-ion battery comprises the sulfide-based solid electrolyte. A vehicle may comprise this lithium-ion battery.

As discussed, the method and system suitably include use of a controller or processer.

In another embodiment, vehicles are provided that comprise an apparatus as disclosed herein.

### BRIEF DESCRIPTION OF THE DRAWINGS

The above and other features of the present disclosure will now be described in detail referring to certain exemplary embodiments thereof illustrated in the accompanying drawings, which are given hereinbelow by way of illustration only, and thus are not limitative of the present disclosure, and wherein:

FIG. 1 shows the structure of a sulfide-based solid electrolyte according to an embodiment of the present disclosure;

FIG. 2 is a view to explain the reason for optimizing the structure of the sulfide-based solid electrolyte;

FIG. 3 shows the crystal structure after optimizing the structure of the sulfide-based solid electrolyte according to an embodiment using density functional theory (DFT); and

FIG. 4 is a graph showing results of measurement of Young's modulus of various examples and comparative examples using density functional theory (DFT).

### DETAILED DESCRIPTION OF EMBODIMENTS

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

Sulfide-based solid electrolytes are being studied worldwide due to high lithium ion conductivity and electrochemical stability. Sulfide-based solid electrolytes are classified into crystalline and amorphous (non-crystalline) depending on the presence or absence of a crystal structure. In the crystalline system, those having thio-LISICON, LGPS (LiGePS), and argyrodite crystal structures are representative. In the amorphous system, those having glass or glass-ceramic structures due to differences in heat treatment temperature are exemplary.

A solid electrolyte having an argyrodite crystal structure is a solid electrolyte that has the same crystal structure as argyrodite ore having a composition of Ag₈GeS₆ and exhibits lithium ion conductivity. In all-solid-state batteries, Li-argyrodite-structured electrolytes having lithium ion (Li⁺) conductivity are typically known to be Li₇PS₆, and Li₇PS₆, some of which are substitution doped with halogen elements.

However, most techniques and patents related to sulfide-based solid electrolytes are limited to improvements in lithium ion conductivity and electrochemical stability.

The sulfide-based solid electrolyte according to the present disclosure is intended to increase crack resistance and durability by improving mechanical properties of the solid electrolyte, especially ductility and fracture strength, which have a significant impact on actual operation of an all-solid-state battery.

The sulfide-based solid electrolyte according to an aspect of the present disclosure may have an argyrodite crystal structure and may be represented by Chemical Formula 1 below.

Li₆₋ₐPS₅₋ₐX₁₊ₐ [Chemical Formula 1]

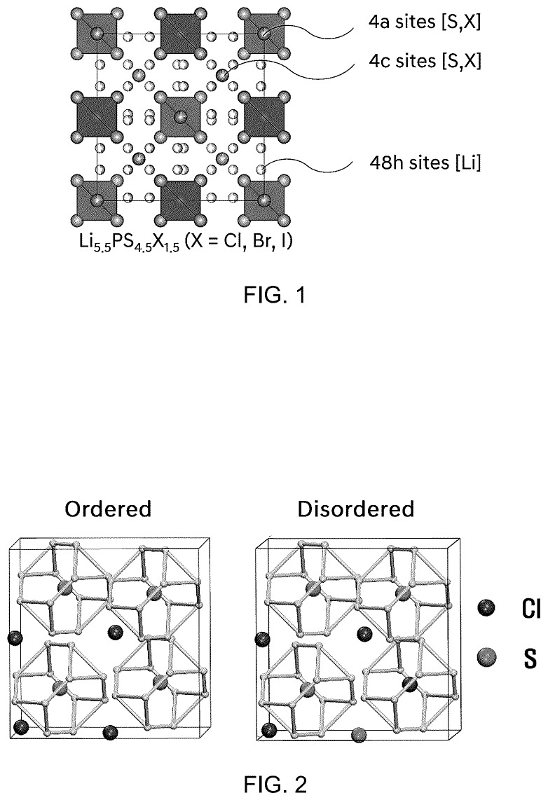

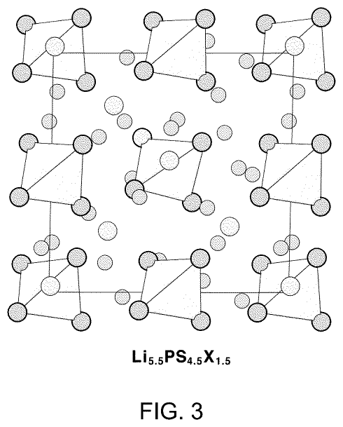

Here, X may be a halogen element containing any one selected from the group consisting of Cl, Br, I, and combinations thereof, and a may satisfy 0≤a≤0.5. For example, the sulfide-based solid electrolyte according to an embodiment of the present disclosure may have the structure shown in FIG. 1.

As such, any one of 4a sites and 4c sites of the argyrodite crystal structure may be substitution doped with the halogen element.

Generally, in a sulfide-based solid electrolyte having an argyrodite crystal structure, the sulfur anion (S²⁻) may be located at 4c sites. In this state, when the 4c sites where the sulfur anion (S²⁻) is located are substitution doped with a halogen element (X), disorder of the crystal structure may increase due to differences in ion size and oxidation number between the sulfur anion (S²⁻) and the halogen anion (X⁻).

As in the present disclosure, when any one of 4a sites and 4c sites is substitution doped with a halogen element and the disorder of the crystal structure increases compared to existing sulfide-based solid electrolytes, bulk modulus, shear modulus, Young's modulus, etc. may decrease, and thus ductility and fracture strength of the solid electrolyte may increase.

In one embodiment, the sulfide-based solid electrolyte according to the present disclosure may have a doping halogen element composition ratio of 1.5. For example, the sulfide-based solid electrolyte may include one represented by Chemical Formula 2 below.

Li_{5.5}PS_{4.5}X_{1.5} [Chemical Formula 2]

Here, X is a halogen element containing any one selected from the group consisting of Cl, Br, I, and combinations thereof.

Also, the halogen element, with which the sulfide-based solid electrolyte according to the present disclosure is substitution doped, may include at least two selected from among Cl, Br, and I.

For example, the sulfide-based solid electrolyte may include one represented by Chemical Formula 3 below.

Li_{5.5}PS_{4.5}(Br,Cl)_{1.5} [Chemical Formula 3]

In addition, the sulfide-based solid electrolyte may include one represented by Chemical Formula 4 below.

Li_{5.5}PS_{4.5}(Cl,I)_{1.5} [Chemical Formula 4]

In addition, the sulfide-based solid electrolyte may include one represented by Chemical Formula 5 below.

Li_{5.5}PS_{4.5}(Br,I)_{1.5} [Chemical Formula 5]

In Chemical Formulas 3 to 5, “(A, B)_{1.5}” means that the elements A and B are included in respective amounts exceeding 0 but the sum of the amounts of the elements A and B is limited to satisfying the composition ratio of 1.5 in the chemical formula.

In addition, the sulfide-based solid electrolyte according to the present disclosure is preferably configured such that halogen elements used for substitution doping extend to a ternary composition including all of Cl, Br, and I. For example, the sulfide-based solid electrolyte may include one represented by Chemical Formula 6 below.

Li_{5.5}PS_{4.5}(Br,Cl,I)_{1.5} [Chemical Formula 6]

In Chemical Formula 6, “(Br, Cl, I)_{1.5}” means that Br, Cl, and I are included in respective amounts exceeding 0 but the sum of the amounts of Br, Cl, and I is limited to satisfying the composition ratio of 1.5 in the chemical formula.

More specifically, the sulfide-based solid electrolyte may include one represented by Chemical Formula 7 below.

Li_{5.5}PS_{4.5}Br_{b}Cl_{c}I_{d} [Chemical Formula 7]

Here, b, c, and d satisfy b+c+d=1.5, 0.25≤b≤1.00, 0.25≤c≤1.00, and 0.25≤d≤0.50.

The sulfide-based solid electrolyte according to the present disclosure may be configured such that halogen elements with which the solid electrolyte is doped extend to a ternary composition including all of Cl, Br, and I as represented by Chemical Formulas 6 and 7, and thus may exhibit excellent lithium ion conductivity, and also, bulk modulus, shear modulus, Young's modulus, etc. may decrease, and thus ductility and fracture strength of the solid electrolyte may increase.

In particular, when the sulfide-based solid electrolyte is represented by Li_{5.5}PS_{4.5}Br_{1.00}Cl_{0.25}I_{0.25}, such mechanical properties may be maximized.

In one embodiment, formation energy of the sulfide-based solid electrolyte having a ternary halogen element composition including all of Cl, Br, and I may be −1.116 to −1.224 eV/atom. When formation energy of the sulfide-based solid electrolyte falls within the above numerical range, a possibility of synthesis may be determined to be high.

In one embodiment, bulk modulus of the sulfide-based solid electrolyte having a ternary halogen element composition including all of Cl, Br, and I may be 24.39 to 26.69 GPa.

In one embodiment, shear modulus of the sulfide-based solid electrolyte having a ternary halogen element composition including all of Cl, Br, and I may be 12.66 to 13.68 GPa.

In one embodiment, Young's modulus of the sulfide-based solid electrolyte having a ternary halogen element composition including all of Cl, Br, and I may be 32.37 to 34.81 GPa.

In one embodiment, Poisson's ratio of the sulfide-based solid electrolyte having a ternary halogen element composition including all of Cl, Br, and I may be 0.27 to 0.29.

When the bulk modulus, shear modulus, Young's modulus, and Poisson's ratio of the sulfide-based solid electrolyte fall within the above numerical ranges, ductility and fracture strength of the solid electrolyte may increase and high crack resistance may be exhibited.

Meanwhile, an all-solid-state battery generally includes an anode current collector, an anode active material layer disposed on the anode current collector and including an anode active material, a solid electrolyte layer disposed on the anode active material layer and including a solid electrolyte, a cathode active material layer disposed on the solid electrolyte layer and including a cathode active material, and a cathode current collector disposed on the cathode active material layer.

The sulfide-based solid electrolyte according to the present disclosure may be included in the solid electrolyte layer. Additionally, the sulfide-based solid electrolyte may be included in the anode active material layer together with the anode active material to form a composite anode layer, or the sulfide-based solid electrolyte may be included in the cathode active material layer together with the cathode active material to form a composite cathode layer.

The anode current collector, anode active material, cathode active material, and cathode current collector that constitute the all-solid-state battery may be those commonly used in the relevant technical field.

A better understanding of the present disclosure may be obtained through the following examples and comparative examples. These examples are not to be construed as limiting the scope of the present disclosure.

### Test Example 1—Possibility of Synthesizing Sulfide-Based Solid Electrolytes Having Various Compositions

In order to confirm the possibility of synthesizing the sulfide-based solid electrolyte according to the present disclosure, formation energy was calculated using density functional theory (DFT).

More specifically, 1) the structure of a sulfide-based solid electrolyte is designed by substituting 4a sites and 4c sites of Li_{5.5}PS_{4.5}X_{1.5} (X═Cl, Br, I) having an argyrodite crystal structure with halogen elements. The specific composition of the designed sulfide-based solid electrolyte is listed in Table 2 below.

2) The structure of the solid electrolyte to be calculated is optimized using DFT. Since the structure of argyrodite designed above may be different from the structure of actually synthesized argyrodite, it may be understood as a process of modifying the structure of argyrodite to be close to the actual structure using DFT.

FIG. 2 is a view to explain anion disorder depending on the substitution doping sites with halogen elements. Referring to FIG. 2, compositions of Li_{5.5}PS_{4.5}X_{1.5} (X═Cl, Br, I) are classified into three unique structure groups as shown in Table 1 below even in the same composition by anion disorder depending on the doping sites with halogen elements, and the actually synthesized argyrodite may be in a state in which the three unique structure groups are mixed.

TABLE 1

| Structure | Site occupancy | | | | | |
|---|---|---|---|---|---|---|
| group | X at 4a | S at 4a | X at 4c | S at 4c | Energy | Properties |
| 1 | 2 | 2 | 4 | 0 | E1 | P1 |
| 2 | 3 | 1 | 3 | 1 | E2 | P2 |
| 3 | 4 | 0 | 2 | 2 | E3 | P3 |

Even when the sulfide-based solid electrolytes have the same composition, there may be a difference in energy level due to anion disorder of 4a sites and 4c sites, and properties may vary depending thereon. Therefore, representative values for specific properties of the sulfide-based solid electrolyte are calculated and used.

$$( \frac{E 1}{E 1 + E 2 + E 3} ) \cdot P 1 + ( \frac{E 2}{E 1 + E 2 + E 3} ) \cdot P 2 + ( \frac{E 3}{E 1 + E 2 + E 3} ) \cdot P 3$$

A representative value for specific properties P may be calculated by independently calculating the corresponding properties from the three structure groups (P1, P2, P3) and then assigning the contribution depending on energy stability. The contribution may refer to the weighted average of the designed argyrodite crystal structure groups. This is due to the assumption that a structure with lower energy has higher stability and is therefore closest to the structure that is actually synthesized.

Meanwhile, all DFT calculations in this Test Example are performed using density functional theory implemented in VASP (Vienna Ab Initio Simulation Package), which is a DFT calculation package based on a plane wave basis set. For all structural optimization and energy calculation, cut-off energy of 520 eV, a K-Point mesh of 2×2×2, and Generalized Gradient Approximation (GGA)-Perdew-Burke-Ernzerhof (PBE) are used.

3) Thereafter, formation energy of the sulfide-based solid electrolyte having the optimized argyrodite crystal structure is calculated, and the value thereof is compared with formation energy of Li₆PS₅Cl as a reference. The results thereof are shown in Table 2 below.

In relation to formation energy, Gibbs free energy (G) is a function indicating the direction of spontaneous chemical reaction and is represented as follows.

$$G = H - TS = E + PV - T$$

Since the DFT calculation of the present disclosure assumes the condition that the system temperature (T) is 0K and the pressure (P) is 0, a change in Gibbs free energy may be calculated using a difference in internal energy (ΔE). Taking this into account, a specific method of calculating the formation energy of the sulfide-based solid electrolyte is as follows.

$$Δ {E}_{f , {Li}_{α} {P}_{β} {S}_{γ} {Cl}_{δ}} = {E}_{{Li}_{α} {P}_{β} {S}_{γ} {Cl}_{δ}} - α \cdot {E}_{Li} - β \cdot {E}_{P} - γ \cdot {E}_{S} - δ \cdot {E}_{Cl}$$

Here, when the formation energy (ΔE_{f}) obtained through DFT calculation has a negative value, energy of the product is more stable than that of the reactant, so the relevant structure is assumed to be thermodynamically stable. Conversely, when the formation energy has a positive value, the relevant structure is assumed to be thermodynamically unstable. Since a thermodynamically stable structure has a high possibility of synthesis, calculation of the formation energy using DFT may ultimately be a criterion for determining the possibility of synthesis of the relevant structure.

TABLE 2

| | Formation energy |
|---|---|
| Composition | per atom (eV/atom) |
| Li₆PS₅Cl (Reference) | −1.191 |
| Li_{5.5}PS_{4.5}Cl_{1.5} | −1.269 |
| Li_{5.5}PS_{4.5}Br_{1.5} | −1.201 |
| Li_{5.5}PS_{4.5}I_{1.5} | −1.116 |
| Li_{5.5}PS_{4.5}Br_{1.25}Cl_{0.25} | −1.219 |
| Li_{5.5}PS_{4.5}Br_{1.00}Cl_{0.50} | −1.229 |
| Li_{5.5}PS_{4.5}Br_{0.75}Cl_{0.75} | −1.239 |
| Li_{5.5}PS_{4.5}Br_{0.50}Cl_{1.00} | −1.249 |
| Li_{5.5}PS_{4.5}Br_{0.25}Cl_{1.25} | −1.260 |
| Li_{5.5}PS_{4.5}Br_{1.25}I_{0.25} | −1.192 |
| Li_{5.5}PS_{4.5}Br_{1.00}I_{0.50} | −1.182 |
| Li_{5.5}PS_{4.5}Br_{0.75}I_{0.75} | −1.171 |
| Li_{5.5}PS_{4.5}Cl_{1.25}I_{0.25} | −1.224 |
| Li_{5.5}PS_{4.5}Cl_{1.00}I_{0.50} | −1.222 |
| Li_{5.5}PS_{4.5}Cl_{0.75}I_{0.75} | −1.204 |
| Li_{5.5}PS_{4.5}Br_{0.25}Cl_{1.00}I_{0.25} | −1.224 |
| Li_{5.5}PS_{4.5}Br_{0.50}Cl_{0.75}I_{0.25} | −1.219 |
| Li_{5.5}PS_{4.5}Br_{0.50}Cl_{0.50}I_{0.50} | −1.198 |
| Li_{5.5}PS_{4.5}Br_{0.75}Cl_{0.50}I_{0.25} | −1.208 |
| Li_{5.5}PS_{4.5}Br_{1.00}Cl_{0.25}I_{0.25} | −1.189 |

As shown in Table 2, the formation energy had a negative value in all combinations designed to be substitution doped with a halogen element X at a composition ratio of 1.5. In particular, it showed only a difference of within ±7% from the formation energy of −1.101 eV/atom of Li₆PS₅Cl with many synthesis reporting cases.

In this way, it can be confirmed that the sulfide-based solid electrolyte having the argyrodite crystal structure designed in the present disclosure has a negative formation energy value according to DFT calculation, and that the formation energy thereof is similar to that of Li₆PS₅Cl, synthesis of which has been reported. Therefore, it is proven that these are thermodynamically stable materials and have a high possibility of actual synthesis.

### Test Example 2—Lattice Constants of Sulfide-Based Solid Electrolytes Having Various Compositions

In order to determine the lattice constant depending on the size of the halogen element with which the sulfide-based solid electrolyte having an argyrodite crystal structure is doped and the relationship between the lattice constant and the physical properties to be described later, lattice constants of the solid electrolytes optimized in Test Example 1 were calculated. The results thereof are shown in Table 3 below.

TABLE 3

| Composition | Cell parameter (Å) | Volume (Å³) |
|---|---|---|
| Li₆PS₅Cl (Reference) | 10.091 (F-43 m) | 1027.63 |
| Li_{5.5}PS_{4.5}Cl_{1.5} | 9.845 | 954.35 |
| Li_{5.5}PS_{4.5}Br_{1.5} | 9.998 | 999.52 |
| Li_{5.5}PS_{4.5}I_{1.5} | 10.189 | 1057.68 |
| Li_{5.5}PS_{4.5}Br_{1.25}Cl_{0.25} | 9.972 | 991.49 |
| Li_{5.5}PS_{4.5}Br_{1.00}Cl_{0.50} | 9.940 | 982.11 |
| Li_{5.5}PS_{4.5}Br_{0.75}Cl_{0.75} | 9.943 | 982.96 |
| Li_{5.5}PS_{4.5}Br_{0.50}Cl_{1.00} | 9.890 | 967.31 |
| Li_{5.5}PS_{4.5}Br_{0.25}Cl_{1.25} | 9.859 | 958.40 |
| Li_{5.5}PS_{4.5}Br_{1.25}I_{0.25} | 10.032 | 1009.70 |
| Li_{5.5}PS_{4.5}Br_{1.00}I_{0.50} | 10.050 | 1014.96 |
| Li_{5.5}PS_{4.5}Br_{0.75}I_{0.75} | 10.089 | 1026.85 |
| Li_{5.5}PS_{4.5}Cl_{1.25}I_{0.25} | 9.874 | 962.55 |
| Li_{5.5}PS_{4.5}Cl_{1.00}I_{0.50} | 9.956 | 986.94 |
| Li_{5.5}PS_{4.5}Cl_{0.75}I_{0.75} | 10.008 | 1002.26 |
| Li_{5.5}PS_{4.5}Br_{0.25}Cl_{1.00}I_{0.25} | 9.973 | 992.02 |
| Li_{5.5}PS_{4.5}Br_{0.50}Cl_{0.75}I_{0.25} | 9.979 | 993.79 |
| Li_{5.5}PS_{4.5}Br_{0.50}Cl_{0.50}I_{0.50} | 10.047 | 1014.14 |
| Li_{5.5}PS_{4.5}Br_{0.75}Cl_{0.50}I_{0.25} | 9.978 | 993.27 |
| Li_{5.5}PS_{4.5}Br_{1.00}Cl_{0.25}I_{0.25} | 10.042 | 1012.72 |

As shown in Table 3, an increase or decrease in the lattice constant was clear depending on the type of halogen element with which the solid electrolyte is doped.

Specifically, upon substitution doping with one type of halogen element, the lattice constant was the greatest when doped with I, followed by Br and Cl.

Upon substitution doping with two types of halogen elements, the lattice constant increased with an increase in the amount of Br or I doped for each group.

Similarly, upon substitution doping with three types of halogen elements, the lattice constant increased with an increase in the amount of Br or I doped.

For reference, the ionic radius of each element is as follows.

R_{Cl—}=1.87Å,R_{Br—}=1.96Å,R_{I—}=2.20 Å

### Test Example 3—Mechanical Properties of Sulfide-Based Solid Electrolytes Having Various Compositions

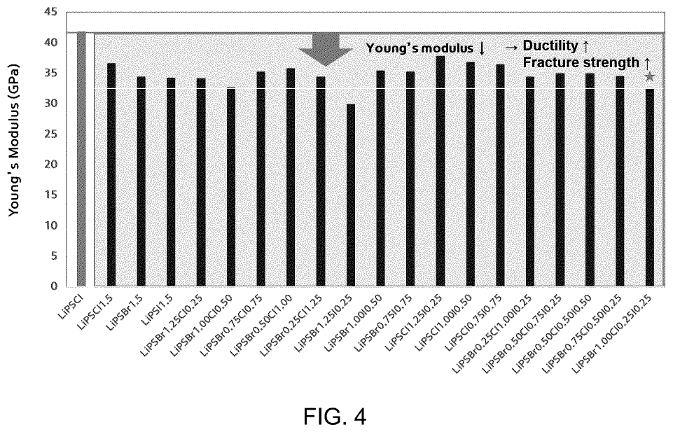

In order to determine mechanical properties of the sulfide-based solid electrolyte optimized in Test Example 1, bulk modulus, shear modulus, Young's modulus, and Poisson's ratio of the sulfide-based solid electrolyte were calculated using DFT. The results thereof are shown in Table 4 below and FIG. 4.

The specific calculation methods and meanings of symbols used therefor are as follows.
Cᵢⱼ=component of elasticity tensor=elastic constant
sᵢⱼ=component of elastic compliance tensor=elastic compliance constant
Kᵥ=Voigt bulk modulus
K_{R}=Reuss bulk modulus
K_{VRH}=Voigt-Reuss-Hill bulk modulus
Gᵥ=Voigt shear modulus
G_{R}=Reuss shear modulus
G_{VRH}=Voigt-Reuss-Hill shear modulus
B=Bulk modulus
G=Shear modulus
E=Young's modulus
v=Poisson's ratio

### 1) Elasticity Tensor

After optimization calculation of the structure using DFT, an elasticity tensor with up to 21 independent components is calculated. Physical properties are calculated using the elasticity tensor and the formula corresponding to each property. The elasticity tensor is as follows.

$$[ \begin{matrix}{C}_{11} & ⋯ & {C}_{16} \\ ⋮ & ⋱ & ⋮ \\ {C}_{16} & ⋯ & {C}_{66}\end{matrix} ] = {C}_{ij}^{cubic} = elasticity tensor = elastic modulus$$

$${s}_{ij} = {C}_{ij}^{- 1}$$

### 2) Method of Calculating Bulk Modulus

$$9 {K}_{V} = ( {C}_{11} + {C}_{22} + {C}_{33} ) + 2 ( {C}_{12} + {C}_{23} + {C}_{31} )$$

$$1 / {K}_{R} = ( {s}_{11} + {s}_{22} + {s}_{33} ) + 2 ( {s}_{12} + {s}_{23} + {s}_{31} )$$

$$2 {K}_{VRH} = ( {K}_{V} + {K}_{R} )$$

Bulk modulus=K_{VRH}

### 3) Method of Calculating Shear Modulus

$$15 {G}_{V} = ( {C}_{11} + {C}_{22} + {C}_{33} ) - ( {C}_{12} + {C}_{23} + {C}_{31} ) + 3 ( {C}_{44} + {C}_{55} + {C}_{66} )$$

$$15 / {G}_{R} = 4 ( {s}_{11} + {s}_{22} + {s}_{33} ) - 4 ( {s}_{12} + {s}_{23} + {s}_{31} ) + 3 ( {s}_{44} + {s}_{55} + {s}_{66} )$$

$$2 {G}_{VRH} = ( {G}_{V} + {G}_{R} )$$

Shear modulus=G_{VRH}

### 4) Method of Calculating Young's Modulus

$$E = 9 BG / ( G + 3 B )$$

### 5) Method of Calculating Poisson's Ratio

$$v = ( 3 B - 2 G ) / ( 6 B + 2 G )$$

TABLE 4

| | Bulk | Shear | Young's | |
|---|---|---|---|---|
| | Modulus | Modulus | Modulus | Poisson's |
| Structure | (GPa) | (GPa) | (GPa) | Ratio |
| Li₆PS₅Cl (reference) | 29.59 | 16.49 | 41.72 | 0.26 |
| Li_{5.5}PS_{4.5}Cl_{1.5} | 26.70 | 14.34 | 36.47 | 0.27 |
| Li_{5.5}PS_{4.5}Br_{1.5} | 25.67 | 13.41 | 34.27 | 0.28 |
| Li_{5.5}PS_{4.5}I_{1.5} | 25.21 | 13.37 | 34.07 | 0.27 |
| Li_{5.5}PS_{4.5}Br_{1.25}Cl_{0.25} | 26.00 | 13.25 | 33.98 | 0.28 |
| Li_{5.5}PS_{4.5}Br_{1.00}Cl_{0.50} | 25.63 | 12.62 | 32.50 | 0.29 |
| Li_{5.5}PS_{4.5}Br_{0.75}Cl_{0.75} | 25.43 | 13.83 | 35.13 | 0.27 |
| Li_{5.5}PS_{4.5}Br_{0.50}Cl_{1.00} | 27.08 | 13.95 | 35.71 | 0.28 |
| Li_{5.5}PS_{4.5}Br_{0.25}Cl_{1.25} | 26.16 | 13.38 | 34.30 | 0.28 |
| Li_{5.5}PS_{4.5}Br_{1.25}I_{0.25} | 24.03 | 11.53 | 29.74 | 0.30 |
| Li_{5.5}PS_{4.5}Br_{1.00}I_{0.50} | 26.01 | 13.87 | 35.32 | 0.27 |
| Li_{5.5}PS_{4.5}Br_{0.75}I_{0.75} | 26.31 | 13.75 | 35.13 | 0.28 |
| Li_{5.5}PS_{4.5}Cl_{1.25}I_{0.25} | 29.64 | 14.62 | 37.66 | 0.29 |
| Li_{5.5}PS_{4.5}Cl_{1.00}I_{0.50} | 28.27 | 14.28 | 36.66 | 0.28 |
| Li_{5.5}PS_{4.5}Cl_{0.75}I_{0.75} | 27.53 | 14.19 | 36.33 | 0.28 |
| Li_{5.5}PS_{4.5}Br_{0.25}Cl_{1.00}I_{0.25} | 26.57 | 13.33 | 34.25 | 0.29 |
| Li_{5.5}PS_{4.5}Br_{0.50}Cl_{0.75}I_{0.25} | 26.37 | 13.60 | 34.81 | 0.28 |
| Li_{5.5}PS_{4.5}Br_{0.50}Cl_{0.50}I_{0.50} | 25.46 | 13.68 | 34.80 | 0.27 |
| Li_{5.5}PS_{4.5}Br_{0.75}Cl_{0.50}I_{0.25} | 26.69 | 13.40 | 34.43 | 0.29 |
| Li_{5.5}PS_{4.5}Br_{1.00}Cl_{0.25}I_{0.25} | 24.39 | 12.66 | 32.37 | 0.28 |

As shown in Table 4, when sulfur(S) was further substituted with a halogen element based on the reference composition of Li₆PS₅Cl, bulk modulus, shear modulus, and Young's modulus all decreased. However, this decrease in mechanical properties was not proportional to the proportion of halogen element in Li_{5.5}PS_{4.5}X_{1.5} (X═Cl, Br, I).

Meanwhile, generally, as Young's modulus decreases, ductility and fracture strength tend to increase. Referring to Table 4 and FIG. 4, for Li_{5.5}PS_{4.5}X_{1.5} (X═Cl, Br, I) in which the proportion of halogen element is increased by 0.5 compared to the reference composition of Li₆PS₅Cl, Young's modulus decreased for all of one-type substitution, two-type substitution, and three-type substitution. However, as described above, it was difficult to confirm the tendency of Young's modulus change depending on the halogen element composition.

Specifically, it can be found that ductility and fracture strength of the sulfide-based solid electrolyte having an argyrodite crystal structure substitution doped with halogen element increase with an increase in the amount of the halogen element, and the effect of the composition ratio is insignificant.

In particular, among Li₆PS₅ (Cl, Br, I)_{1.5} doped with all three types of halogen elements, Li_{5.5}PS_{4.5}Br_{1.00}Cl_{0.25}I_{0.25} can be confirmed to have lower modulus values (bulk modulus, shear modulus, Young's modulus, Poisson's ratio) than other compositions. Therefore, it is predicted that, when an all-solid-state battery is manufactured using the sulfide-based solid electrolyte having the above composition ratio and high ductility and fracture strength, crack resistance is high.

As is apparent from the above description, a sulfide-based solid electrolyte according to the present disclosure has an argyrodite crystal structure and is substitution doped with at least two types of halogen elements, thereby improving ductility and fracture strength. In particular, substitution doping with three types of halogen elements is possible.

Here, these mechanical properties can be further improved when 4a sites or 4c sites of the sulfide-based solid electrolyte having an argyrodite crystal structure are substitution doped with the three types of halogen elements.

The effects of the present disclosure are not limited to the above-mentioned effects. It should be understood that the effects of the present disclosure include all effects that can be inferred from the description of the present disclosure.

As the embodiments of the present disclosure have been described above, those skilled in the art will appreciate that various modifications and alterations are possible through change, deletion or addition of components without departing from the scope and spirit of the present disclosure as described in the accompanying claims, which will also be said to be included within the scope of rights of the present disclosure.

What is claimed is:

1. A sulfide-based solid electrolyte comprising an argyrodite crystal structure and represented by a formula:
Li₆₋ₐPS₅₋ₐX₁₊ₐ,
wherein X is one or more halogen element selected from the group consisting of Cl, Br, I, and combinations thereof,
wherein a is from 0 to 0.5,
wherein the argyrodite crystal structure is doped with the one or more halogen element at 4a sites, 4c sites, or both.

2. The sulfide-based solid electrolyte of claim 1 represented by a formula:
Li_{5.5}PS_{4.5}X_{1.5}
wherein X is one or more halogen element selected from the group consisting of Cl, Br, I, and combinations thereof.

3. The sulfide-based solid electrolyte of claim 1, wherein X comprises at least two halogen elements selected from the group consisting of Cl, Br, and I.

4. The sulfide-based solid electrolyte of claim 1 represented by a formula:
Li_{5.5}PS_{4.5}(Br,Cl)_{1.5}.

5. The sulfide-based solid electrolyte of claim 1 represented by a formula:
Li_{5.5}PS_{4.5}(Cl,I)_{1.5}.

6. The sulfide-based solid electrolyte of claim 1 represented by a formula:
Li_{5.5}PS_{4.5}(Br,I)_{1.5}.

7. The sulfide-based solid electrolyte of claim 1, wherein X comprises all three halogen elements Cl, Br, and I.

8. The sulfide-based solid electrolyte of claim 1 represented by a formula:
Li_{5.5}PS_{4.5}(Br,Cl,I)_{1.5}.

9. The sulfide-based solid electrolyte of claim 1 represented by a formula:
Li_{5.5}PS_{4.5}Br_{b}Cl_{c}I_{d};
wherein b is from 0.25 to 1.00, c is from 0.25 to 1.00, and d is from 0.25 to 0.50, and
wherein b+c+d=1.5.

10. The sulfide-based solid electrolyte of claim 7 represented by a formula:
Li_{5.5}PS_{4.5}Br_{1.00}Cl_{0.25}I_{0.25}.

11. The sulfide-based solid electrolyte of claim 7, wherein formation energy of the sulfide-based solid electrolyte is from about −1.116 to about −1.224 eV/atom.

12. The sulfide-based solid electrolyte of claim 7, wherein bulk modulus of the sulfide-based solid electrolyte is from about 24.39 to about 26.69 GPa.

13. The sulfide-based solid electrolyte of claim 7, wherein shear modulus of the sulfide-based solid electrolyte is from about 12.66 to about 13.68 GPa.

14. The sulfide-based solid electrolyte of claim 7, wherein Young's modulus of the sulfide-based solid electrolyte is from about 32.37 to about 34.81 GPa.

15. The sulfide-based solid electrolyte of claim 7, wherein Poisson's ratio of the sulfide-based solid electrolyte is from about 0.27 to about 0.29.

16. The sulfide-based solid electrolyte of claim 1, wherein the electrolyte further comprises an anion selected from the group consisting of F- and combinations of F- with Cl, Br, or I.

17. The sulfide-based solid electrolyte of claim 1, wherein the electrolyte is synthesized using a ball milling process to ensure uniform distribution of the halogen elements within the argyrodite crystal structure.

18. The sulfide-based solid electrolyte of claim 1, wherein the halogen elements are doped at both 4a and 4c sites to create a more disordered crystal structure, thereby improving ductility and fracture strength.

19. A lithium ion battery comprising the sulfide-based solid electrolyte of claim 1.

20. A vehicle comprising the lithium ion battery of claim 19.
